(19) United States
(12) Patent Application Publication
(10) Pub. No.: US 2010/0161834 A1
(43) Pub. Date: Jun. 24, 2010

(54) USER INTERFACE BETWEEN A MICROCONTROLLER AND A FLEXRAY COMMUNICATIONS MODULE; FLEXRAY USER; AND METHOD FOR TRANSMITTING MESSAGES VIA SUCH AN INTERFACE

(76) Inventors: Josef Newald, Stuttgart (DE); Markus Ihle, Jettenburg (DE)

Correspondence Address: KENYON & KENYON LLP, ONE BROADWAY, NEW YORK, NY, 10004, US

(21) Appl. No.: 12/083,272

(22) PCT Filed: Oct. 5, 2006
(86) PCT No.: PCT/EP2006/067085

§ 371 Date: Oct. 2, 2009

(30) Foreign Application Priority Data
Oct. 6, 2005 (DE) 10 2005 048 582.0

(51) Int. Cl. G06F 3/00; G06F 13/28

(52) U.S. Cl. 710/8; 710/23; 710/52

(57) ABSTRACT

A user interface between a FlexRay communications module which is connected to a FlexRay communications link over which messages are transmitted and which includes a message memory for buffer storing messages from the FlexRay communications link or for the FlexRay communications link, and a microcontroller which is assigned to the FlexRay communications module and which includes a microprocessor and a direct memory access (DMA) controller for exchanging data with the message memory. In order for the DMA controller of the microcontroller to be connected more effectively to the FlexRay communications module, the user interface has a state machine, which, once configured by the microprocessor of the microcontroller, independently coordinates and controls a data transmission between the message memory of the FlexRay communications module and the DMA controller.

### FIELD OF THE INVENTION

The present invention relates to a user interface between a FlexRay communications module which is connected to a FlexRay communications link over which messages are transmitted and which includes a message memory for buffer storing messages from the FlexRay communications link or for the FlexRay communications link, and a microcontroller which is assigned to the FlexRay communications module and which includes a microprocessor and a direct memory access (DMA) controller for exchanging data with the message memory, and to a related method.

### BACKGROUND INFORMATION

In recent years, there has been a dramatic increase in the internetworking of control units, sensor systems and actuatorics via a communications system and a communications link designed as a bus system, in modern motor vehicles, but also in machine manufacturing, especially in the machine tool sector, and in the automation field. In this context, synergistic effects are attainable when functions are distributed among a plurality of control units. One speaks in this case of distributed systems. To an increasing degree, communication among various users is carried out via a communications system designed as a bus system. The communications traffic on the bus system, access and receiving mechanisms, and error handling are governed by a protocol.

A known protocol used for this purpose is the FlexRay protocol, which is presently based on the FlexRay protocol specification v2.0. The FlexRay protocol defines a rapid, deterministic and fault-tolerant bus system which is especially conceived for use in a motor vehicle. The FlexRay protocol provides for data to be transmitted in accordance with a time division multiple access (TDMA) method. Data are transmitted via the communications link in regularly repeating transmission cycles which are subdivided into a plurality of data frames, also described as time slots. The users, respectively the messages to be transmitted, have fixed time slots allocated thereto, within which they have exclusive access to the communications link. The time slots are repeated within the fixed transmission cycles, making it possible for the point in time when a message is transmitted over the bus to be precisely predicted and for the bus access to be executed deterministically.

To allow the bandwidth to be optimally utilized for transmitting messages on the bus system, FlexRay subdivides the transmission cycle, which can also be described as cycle or bus cycle, into a static and a dynamic segment. The fixed time slots reside in the static segment at the beginning of a bus cycle. In the dynamic segment, the time slots are allocated dynamically. In this segment, each exclusive bus access is permitted for only a brief time period, for one or a plurality of so-called minislots. Only when a bus access takes place within a minislot is the time slot extended by the requisite time period. Thus, bandwidth is only used when it is also actually needed.

FlexRay communicates over two physically separate lines of the communications link, each having a maximum data rate of 10 Mbit/s (10 Mbaud). One bus cycle is completed every 5 ms, in many communications systems, even every 2.5 ms. The two channels correspond to the physical layer, in particular of the OSI (open systems architecture) layer model. The two channels are used primarily for the redundant and thus fault-tolerant transmission of messages, but are also capable of transmitting different types of messages, in which case, the data rate would be doubled. However, FlexRay can also be operated at lower data rates.

To implement synchronous functions and optimize the bandwidth by using small intervals between two messages, the users, respectively the distributed components in the communications network, require a common time base, the so-called global time. For the clock synchronization, synchronization messages are transmitted in the static segment of the cycle, a special algorithm being used to correct the local clock time of a user in accordance with the FlexRay specification in such a way that all local clocks run synchronously to a global clock.

A FlexRay user, which can also be described as a FlexRay network node or host, includes a user processor or host processor, a FlexRay controller or communications controller, as well as a so-called bus guardian in the context of a bus monitoring. The user processor delivers and processes the data which are transmitted via the FlexRay communications controller and the FlexRay communications link. Messages or message objects may be configured, for instance, for up to 254 data bytes for communication in a FlexRay network.

To couple a FlexRay communications link, over which messages are transmitted, to a FlexRay user, the German publication DE 10 2005 034 744 (not yet published at the application date of the present invention) describes using a FlexRay communications module, which is connected via a user interface at the user and via another connection at the communications link. In this context, to transmit the messages between the user and the communications link in the communications module, a configuration for storing the messages is provided. The transmission is controlled by a state machine.

An interface module composed of two parts is provided in the communications module, the one submodule being user-independent and the other submodule being user-specific. The user-specific submodule, also described as customer CPU interface (CIF), connects a customer-specific user in the form of a user-specific host CPU to the FlexRay communications module. The user-specific submodule, also described as generic CPU interface (GIF), constitutes a generic, thus general CPU interface, via which different customer-specific host CPUs are connectable to the FlexRay communications module via corresponding user-specific submodules, thus customer CPU interfaces (CIFs). This makes it possible for the communications module to be easily adapted to various users, since the user-specific submodule merely needs to be varied as a function of the user, while the user-independent submodule and the remaining communications module can always be identical in design. Thus, with the aid of the communications module, a standard interface is derived for connecting any given FlexRay user to a FlexRay communications link, it being possible to flexibly adapt the interface to users of any given design or type by simply varying the user-specific submodule. In this context, the submodules may also be implemented within the one interface module as software, thus each submodule as a software function.

Within the FlexRay communications module, the state machine can be hardwired in the hardware. The sequences can likewise be hardwired in the hardware. Alternatively, within the communications module, the state machine can also be freely programmable by the user via the user interface.

The information may include the access type and/or the access procedure and/or the access address and/or the data size and/or control information pertaining to the data and/or at least one piece of information pertaining to data protection.

Under the related art, the message memory of the FlexRay communications module may be a single-ported RAM (random access memory). This RAM memory stores the messages or message objects, thus the actual useful data, together with configuration and status data. The precise structure of the message memory of the known communications module can be inferred from the mentioned German publication DE 10 2005 034 744.

It turns out that the messages are transmitted between the message memory of the FlexRay communications module and the FlexRay user only relatively slowly, while drawing upon considerable resources on the part of the user, particularly with regard to the computing power required of the host CPU and the required memory capacity. In the case of the known user interface between the FlexRay communications module and the FlexRay user, a constant activity of the host CPU (possibly DMA, direct memory access) is required in order to transfer newly received buffer contents of the message memory of the communications module into the memory of the host CPU. Using so-called polling, the host CPU can regularly check whether new messages have been stored in the message memory of the user interface. It is not possible for the host CPU to directly access the message memory of the communications module. This proves to be disadvantageous, particularly when reaching the upper data rate limit of the FlexRay communications link. In addition, wait periods of the host CPU must be taken into account when setting up the registers, etc. Under related art methods, a FlexRay user has a microprocessor and a DMA controller in order to coordinate and control the data transmission between the message memory of the FlexRay communications module and the user. It is problematic in this regard, however, that the messages are not stored sequentially, thus in succession, in the message memory, but rather are selectively distributed among specific areas of the message memory. Invariably, the DMA controller is only able to access data from contiguous areas of the message memory. Consequently, under the related art, the DMA controller must be set up and started several times in order to transmit data between the message memory and the user. Each time the DMA controller is set up and started, it is necessary for a substantial data volume of configuration, coordination and control parameters to be transmitted. Upon completion of each DMA controller invocation, the end of the data transmission is communicated to the microprocessor, for example by polling executed by the microprocessor or by an interrupt instruction initiated by the DMA controller. Both require considerable resources (computing and memory capacity) in the microprocessor. Thus, under the related art, programming the DMA controller for the purpose of data transmission is hardly worthwhile or is only practical in exceptional cases. Thus, in summary, the connection of the DMA controller to the FlexRay communications module is not optimal under the related art.

An object of the exemplary embodiments and/or exemplary methods of the present invention is, therefore, to devise a way for the DMA controller of the microcontroller to be connected more effectively to the FlexRay communications module to allow data to be transmitted between the message memory of the communications module and the DMA controller more rapidly and, above all, more efficiently in terms of conserving resources.

### SUMMARY OF THE INVENTION

To achieve this objective, starting out from the user interface of the type mentioned at the outset, it is provided for the user interface to have a state machine, which, once configured by the microprocessor of the microcontroller, independently coordinates and controls a data transmission between the message memory of the FlexRay communications module and the DMA controller.

The exemplary embodiments and/or exemplary methods of the present invention relates to a user interface between a FlexRay communications module which is connected to a FlexRay communications link over which messages are transmitted and which includes a message memory for buffer storing messages from the FlexRay communications link or for the FlexRay communications link, and a microcontroller which is assigned to the FlexRay communications module and which includes a microprocessor and a direct memory access (DMA) controller for exchanging data with the message memory.

The exemplary embodiments and/or exemplary methods of the present invention also relates to a FlexRay user which has a microcontroller and a FlexRay communications module which is connected to a FlexRay communications link over which messages are transmitted and which includes a user interface between the microcontroller and the communications module. The microcontroller includes a microprocessor and a direct memory access (DMA) controller. The communications module includes a message memory for buffer storing messages from the FlexRay communications link or for the FlexRay communications link.

Finally, the exemplary embodiments and/or exemplary methods of the present invention also relates to a method for transmitting data between a message memory of a FlexRay communications module which is connected to a FlexRay communications link over which messages are transmitted, and a direct memory access (DMA) controller of a microcontroller.

Thus, the exemplary embodiments and/or exemplary methods of the present invention provides for a state machine to be interposed between the microcontroller of a FlexRay user and a FlexRay communications module of the user to order to modify the user interface in a way that makes it worthwhile to set up and start the DMA controller of the microcontroller. In other words, the state machine ensures that the data or messages to be transmitted are presented to the DMA controller in such an optimized way that, in response to one single invocation thereof, it will be able to transmit even greater data volumes or a plurality messages. Thus, in accordance with the exemplary embodiments and/or exemplary methods of the present invention, one single access is effectively composed of the previously required many small accesses.

The microprocessor of the microcontroller of the user first configures the state machines, instructing it whether it should read or write, which messages (message numbers) should be transmitted, and how long the messages to be transmitted are. On the basis of this information, the state machine then accesses the FlexRay communications module in such a way that the desired data or messages are transmitted between the message memory and the DMA controller in a read or write operation. The state machine provides the DMA controller, so to speak, with the intelligence that it needs for more complex accesses to greater data volumes, in particular for a plurality of messages, possibly even in distributed address ranges of the message memory. In other words, the state machine produces a virtual contiguous address range, making it practical for the first time for the DMA controller to be used, since the number of data to be transmitted (for setting up the DMA controller) and the number of interrupts (at the end of a DMA controller cycle) are significantly reduced.

The DMA controller may read from or write to the same address of the message memory or from upstream buffer memories for buffer storing the data to be transmitted between the message memory and the DMA controller. To read data, the DMA controller advantageously always accesses an output buffer of the FlexRay communications module and, to write data, advantageously always accesses an input buffer.

One advantageous embodiment of the present invention provides for the user interface to have configuration and status registers that the microprocessor of the microcontroller has access to, to configure the state machine. Thus, the microprocessor configures the state machine by writing appropriate configuration parameters into the configuration and status registers of the user interface. The registers may be implemented as flip-flops or as part of a large memory, for example of a random access memory (RAM), thus RAM-implemented. The configuration parameters relate, for example, to the following information:
reading- or writing-type data transmission;
information on (message numbers of) the messages to be transmitted; and
length of the messages to be transmitted.

One exemplary embodiment of the present invention provides for the user interface to have a sequence memory, in which references to specific messages stored in the message memory and information pertaining to the messages are stored, to coordinate and control the data transmission, the state machine invoking entries in the sequence memory. The sequence memory may be a RAM and includes a plurality of, and which may be 128, fields having sequence entries. The sequence entries include, for example, an identifier (for instance a number) of the sequence entry, an identifier or a reference (for instance a buffer number) to one or a plurality of messages (a so-called buffer) of the message memory or of the buffer memory, and the size of the message (of the buffer). The various sequence entries may be selectively invoked by the state machine in accordance with microprocessor specifications. The sequence entries may be invoked as unmodified entries in the stored form or in an adapted form. In the adapted form, specific parameter values are included when the sequence entry is invoked in order to adapt variable parameters of the sequence entry.

The sequence entries in the sequence memory may pertain to frequently occurring transmission sequences which are stored in advance and invoked as needed. In this manner, by invoking one single sequence or subsequence (of one or of a plurality of sequence entries), a transmission of voluminous data may be initiated between the message memory and the DMA controller. When the sequences are used, the configuration parameters, which are transmitted at the beginning of the data transmission from the microprocessor of the microcontroller into the configuration and status registers, may also include an identifier (for example the numbers) of one or of a plurality of sequence entries which are to be invoked by the state machine in the course of the data transmission.

The messages to be transmitted between the message memory and the user each advantageously include a header segment, in particular including configuration data and control data, and a data segment including useful data, the state machine controlling the data transmission between the message memory and the DMA controller in such a way that, for each message, the header segment is read in before the data segment.

The state machine may control the data transmission between the message memory and the DMA controller in such a way that, prior to reading in of the data segment, the data contained in the header segment are evaluated, and the process of reading in the data segment is controlled as a function of the result of the evaluation of the data of the header segment. Thus, before the useful data are transmitted, the status is read in. This makes it possible to prevent the entire data segment from being transmitted in the case of empty data in the data segment. Rather, those address ranges of the data segment which contain the useful data (so-called payload) may be selected; the address ranges having empty data are not considered during the transmission and are simply skipped. The transmission rate may be increased in this manner.

In accordance with another advantageous embodiment of the present invention, the FlexRay communications module has at least one buffer, and may have at least one input buffer and at least one output buffer, for buffer storing data to be transmitted between the message memory of the communications module and the DMA controller, which may be for buffer storing at least one message stored in the message memory, the state machine independently coordinating and controlling the data transmission between the message memory and the at least one buffer, as well as between the at least one buffer and the DMA controller. The at least one buffer is located between the message memory of the FlexRay communications module and the state machine of the user interface. One output buffer may be provided for the read access to the message memory and one input buffer for the write access, respectively.

In accordance with another exemplary embodiment, the at least one buffer includes a partial buffer and one shadow memory belonging to the partial buffer, the state machine coordinating and controlling the data transmission in such a way that the writing to and/or reading of the partial buffer and the shadow memory take place in an alternating process. A significantly higher data rate may be achieved by writing into or reading from partial buffers and shadow memories in an alternating process, since data may already be written into the partial buffer again while data are still being read out from the shadow memory and, conversely, data may already be written into the shadow memory again while data are still be read out from the partial buffer.

Finally, it is provided that the FlexRay communications module have at least one control register that belongs to the at least one buffer, the state machine having access to the control register in order to coordinate and control the data transmission between the message memory and the at least one buffer. The communications module may be informed via the control registers as to whether new data are pending for transmission (and are to be transmitted) and at which address in the message memory they are to be stored, respectively from which address they are to be collected.

Starting out from the FlexRay user of the type mentioned at the outset, another approach for achieving the objective of the present invention provides for the user interface to have a state machine, which, once configured by the microprocessor of the microcontroller, independently coordinates and controls a data transmission between the message memory of the FlexRay communications module and the DMA controller.

Starting out from the method of the type mentioned at the outset, yet another approach for achieving the objective of the exemplary embodiments and/or exemplary methods of the present invention provides for a state machine, which, as part of a user interface, is located between the microcontroller and the FlexRay communications module, to be configured by a microprocessor of the microcontroller, and, following the configuration, for the data transmission to be independently coordinated and controlled by the state machine.

One advantageous embodiment of the present invention provides for configuration parameters to be stored by the microprocessor of the microcontroller in configuration and status registers of the user interface in order to configure the state machine.

One exemplary embodiment of the present invention provides for references to specific messages stored in the message memory and information pertaining to the messages to be stored in a sequence memory of the user interface, to coordinate and control the data transmission, the state machine invoking entries in the sequence memory.

The FlexRay communications module advantageously has at least one buffer, which may be at least one input buffer and at least one output buffer, for buffer storing data to be transmitted between the message memory of the communications module and the DMA controller, which may be for buffer storing at least one message stored in the message memory, coordination and control parameters being stored by the state machine in control registers belonging to the at least one buffer to control and coordinate the data transmission.

Other features and advantages of the exemplary embodiments and/or exemplary methods of the present invention are explained in greater detail in the following with reference to the figures.

### BRIEF DESCRIPTION OF THE DRAWINGS

FIG. 1 shows in a schematic representation, a communications module and connection thereof to a communications link, and a communications or host user of a FlexRay communications system.

FIG. 2 shows a special specific embodiment of the communications module from FIG. 1, as well as connection thereof, in detail.

FIG. 3 shows the structure of a message memory of the communications module from FIG. 2.

FIGS. 4, 5 and 6 show a schematic representation of the architecture and the process of a data access in the direction from the user to the message memory.

FIGS. 7, 8 and 9 show the architecture and the process of a data access in the direction from the message memory to the user.

FIG. 10 shows a schematic representation of the structure of a message handler and of finite state machines contained therein.

FIG. 11 shows schematically, components of the communications module from FIGS. 1 and 2, as well as the user, and the corresponding data paths controlled by the message handler.

FIG. 12 shows the distribution of access to the message handler with respect to the data paths in FIG. 11.

FIG. 13 shows a user interface according to the present invention having a state machine.

FIG. 14 shows the state machine between the FlexRay communications module and the FlexRay user in detail.

FIG. 15 shows the signal routes in the context of a read operation via the user interface according to the present invention.

FIG. 16 shows the signal routes in the context of a read write operation via the user interface according to the present invention.

### DETAILED DESCRIPTION

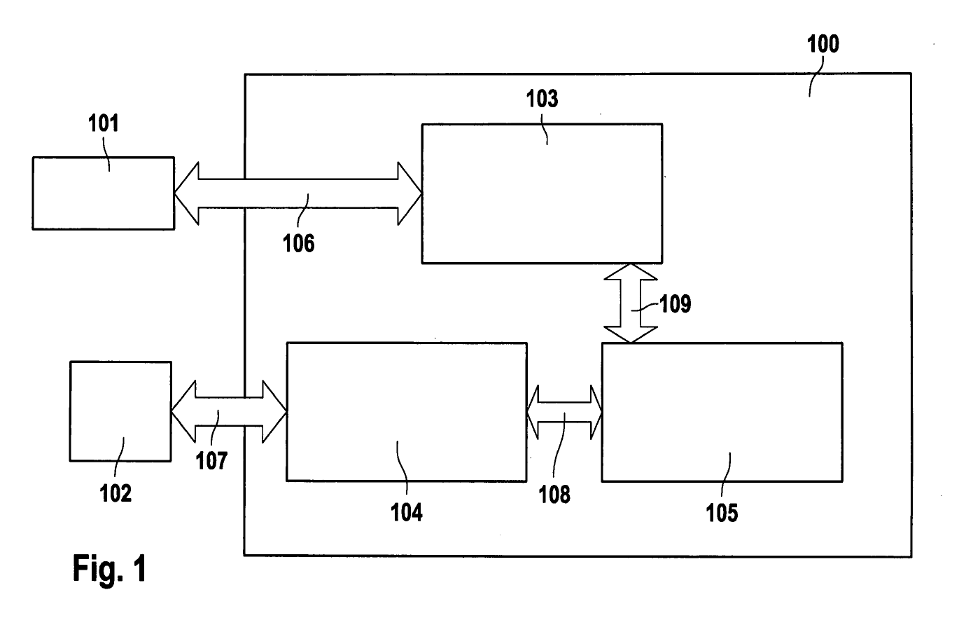

FIG. 1 schematically shows a FlexRay communications module 100 for connecting a user or host 102 to a FlexRay communications link 101, thus the physical layer of the FlexRay. It is designed, for example, as a FlexRay data bus, which may have two transmission lines. To that end, FlexRay communications module 100 is connected via a connection 107 to the user or user processor 102, and via a connection 106 to communications link 101. In terms of a problem-free connection with respect to transmission times, on the one hand, and with respect to data integrity, on the other hand, essentially three configurations are schematically differentiated within the FlexRay communications module. A first configuration 105 is used for storage, in particular in the manner of a clipboard, of at least a portion of the messages to be transmitted. Between user 102 and this first configuration 105, a second configuration 104 is connected via connections 107 and 108. In the same way, a third configuration 103 is connected via connections 106 and 109 between communications link 101 and first configuration 105, a very flexible inputting and outputting of data as part of messages, in particular FlexRay messages, into and out of first configuration 105 being thereby attainable at optimal speed, while ensuring data integrity.

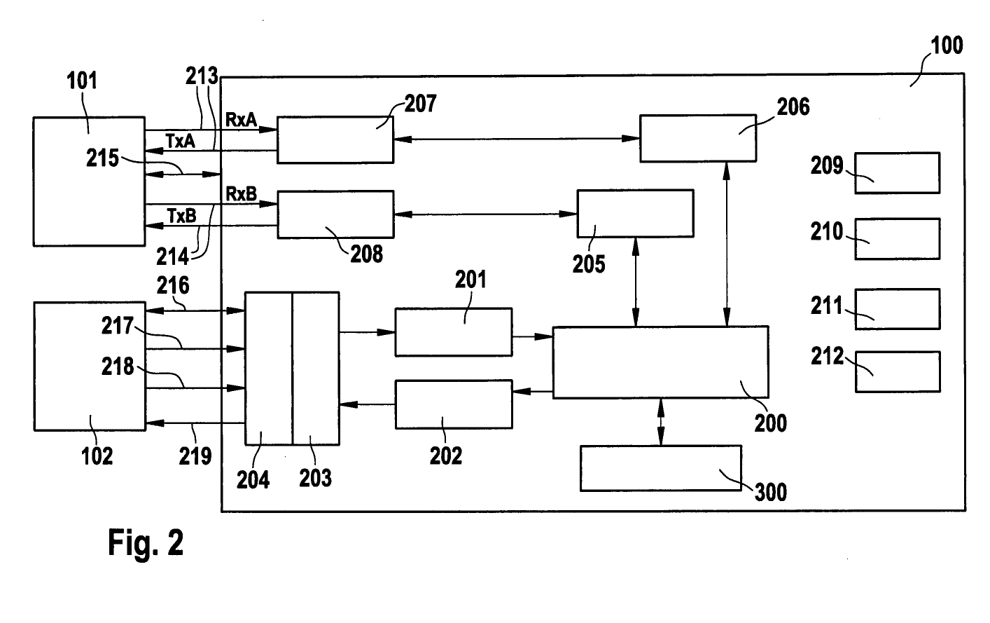

This communications module 100 is shown again in greater detail in FIG. 2, in an exemplary embodiment. Also shown in greater detail are connections 106 through 109 in question. To connect the FlexRay communications module 100 to FlexRay user 102 or to the host processor, second configuration 104 includes an input buffer (IBF) 201, an output buffer (OBF) 202, as well as an interface module composed of two parts 203 and 204, the one submodule 203 being user-independent and second submodule 204 being user-specific. User-specific submodule 204 (customer CPU interface CIF) connects a user-specific host CPU 102, thus a customer-specific user, to FlexRay communications module 100. To that end, a bidirectional data line 216, an address line 217, as well as a control input 218 are provided. An interrupt output denoted by 219 is likewise provided. User-specific submodule 204 communicates with a user-independent submodule 203 (generic CPU interface, GIF), i.e., the FlexRay communications module, also termed FlexRay IP module, has a generic, thus general CPU interface 203, to which a large number of different customer-specific host CPUs are connectable via corresponding user-specific submodules 204, thus customer CPU interfaces CIF. Thus, it is merely necessary to vary submodule 204 as a function of user 102, signifying a substantially lower outlay. CPU interface 203 and remaining communications module 100 may be taken over without modification.

Input buffer 201 and output buffer 202 may be configured in one shared memory module, or else in separate memory modules. In this context, input buffer 201 is used for buffer storing messages for transmission to a message memory 300. Input buffer module 201 may be for storing two complete messages composed of one header segment, in particular having configuration data, and one data segment or payload segment. Input buffer 201 has a two-part design (partial buffer and shadow memory), which makes it possible for the transmission between user CPU 102 and message memory 300 to be accelerated by alternating the writing to the two parts of the input buffer, i.e., by alternating access thereto. In the same way, output buffer (OBF) 202 is used for buffer storing messages for transmission from message memory 300 to user CPU 102. Output buffer 202 is also designed for storing two complete messages composed of a header segment, in particular having configuration data, and of a data segment, thus payload segment. In this case as well, output buffer 202 is subdivided into two parts, a partial buffer and a shadow memory, likewise permitting acceleration of the transmission between user CPU or host CPU 102 and message memory 300 by alternating the reading from the two parts, i.e., by alternating access thereto. This second configuration 104, composed of blocks 201 through 204, is connected to first configuration 105, as shown.

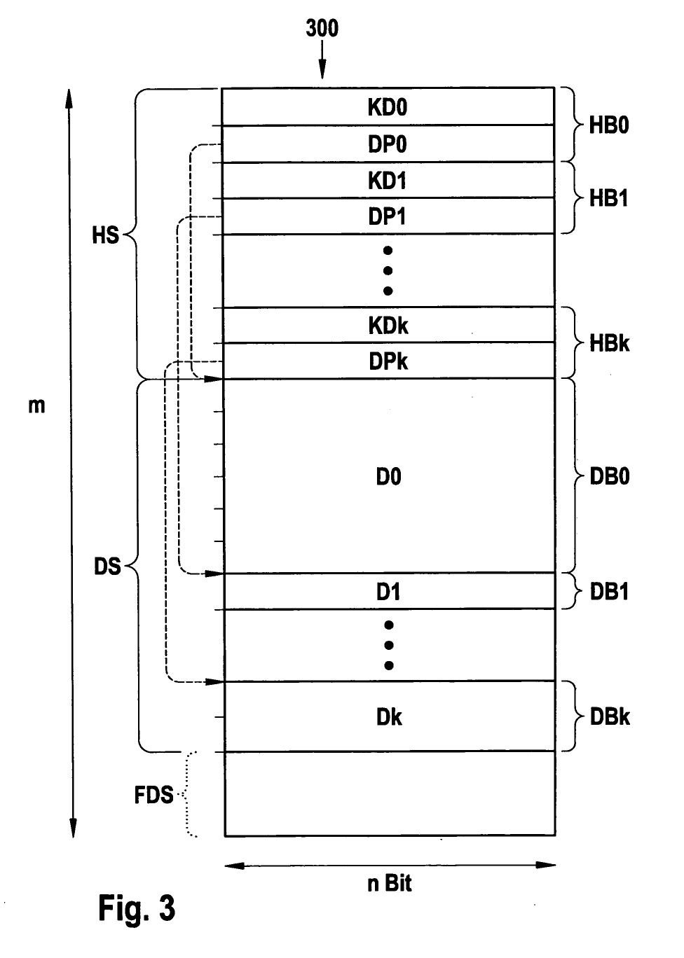

Configuration 105 is composed of a message handler (MHD) 200 and a message memory 300 (message RAM). Message handler 200 checks or controls the data transfer between input buffer 201, as well as output buffer 202 and message memory 300. It likewise checks or controls the data transfer in the other direction via third configuration 103. Message memory 300 may be a single-ported RAM. This RAM memory stores the messages or message objects, thus the actual data, together with configuration and status data. The precise structure of message memory 300 is shown in greater detail in FIG. 3.

Third configuration 103 is composed of blocks 205 through 208. In accordance with the two channels characteristic of the FlexRay physical layer, this configuration 103 is subdivided into two data paths, each having two data directions. This is clearly shown by connections 213 and 214, in which the two data directions are illustrated for channel A by RxA and TxA for reception (RxA) and transmission (TxA), as well as for channel B by RxB and TxB. Connection 215 denotes an optional bidirectional control input. Third configuration 103 is connected via a first buffer 205 for channel B and a second buffer 206 for channel A. These two buffers (transient buffer RAMs: RAM A and RAM B) are used as buffer memories for the data transmission from and, respectively, to first configuration 105. In conformance with the two channels, these two buffers 205 and 206 are each connected to one interface module 207 and 208, which contain the FlexRay protocol controllers or bus protocol controllers, composed of a transmit/receive shift register and of the FlexRay protocol finite state machine. Thus, the two buffers 205 and 206 are used as buffer memories for the data transmission between the shift registers of the interface modules or FlexRay protocol controllers 207 and 208 and message memory 300. Here as well, each buffer 205 or 206 advantageously stores the data fields, thus the payload segment or data segment of two FlexRay messages.

Also illustrated within communications module 100 is the global time unit (GTU), designated by 209, which is responsible for representing the global time base within FlexRay, i.e., microtick μT and macrotick MT. Global time unit 209 is likewise used as a basis for regulating the fault-tolerant clock synchronization of the cycle counters and the control of the time sequences in the static and dynamic segment of the FlexRay. Block 210 represents the general system control (system universal control SUC) which checks and controls the operational modes of the FlexRay communications controller. These include wake-up, startup, reintegration or integration, normal operation and passive operation.

Block 211 represents the network and error management (NEM), as described in the FlexRay protocol specification v2.0. Finally, block 212 represents the interrupt control (INT), which manages the status and error interrupt flags and checks or controls interrupt outputs 219 to user CPU 102. Moreover, block 212 includes an absolute and a relative timer for producing timer interrupts.

Message objects or messages (message buffer) may be configured with up to 254 data bytes for communication within a FlexRay network. Message memory 300 is, in particular, a message RAM which is capable of storing up to a maximum of 128 message objects, for example. All functions which pertain to the handling or management of the messages themselves are implemented in message handler 200. These include, for example, acceptance filtering, transfer of messages between the two FlexRay protocol controller blocks 207 and 208 and message memory 300, i.e., the message RAM, as well as controlling the transmit sequence and supplying configuration data and status data, respectively.

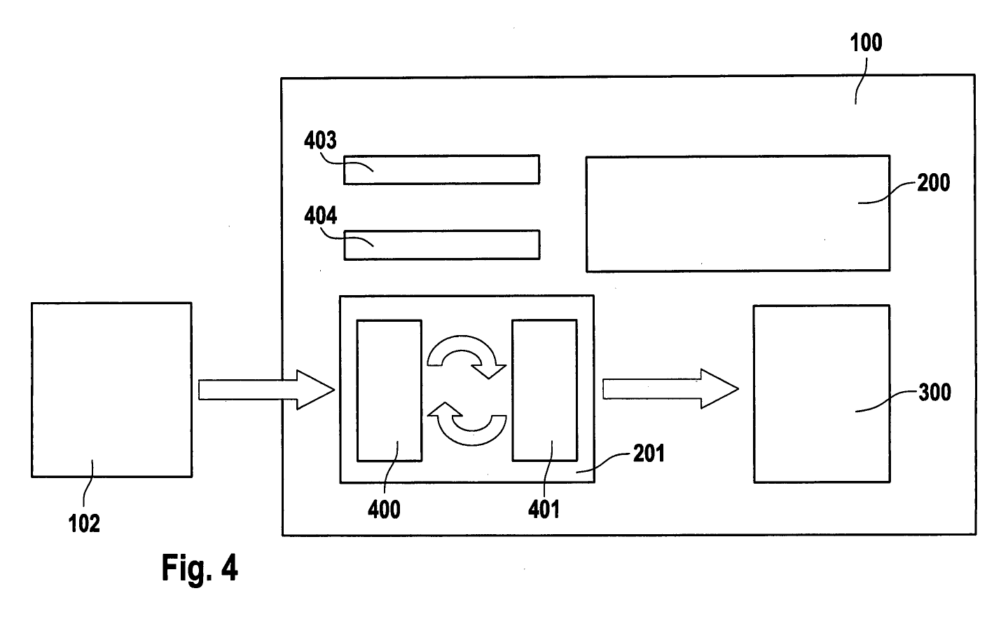

An external CPU, thus an external processor, user processor 102, may directly access the register of FlexRay communications module 100 via user interface 107, using user-specific part 204. In this context, a multiplicity of registers is used. These registers are used to configure and control the FlexRay protocol controller, thus interface modules 207 and 208, message handler (MHD) 200, global time unit (GTU) 209, system universal controller (SUC) 210, network and error management unit (NEM) 211, interrupt controller (INT) 212, as well as the access to the message RAM, thus message memory 300, and to indicate the corresponding status, as well. At least parts of these registers are described in greater detail in FIGS. 4 through 6 and 7 through 9. A FlexRay communications module 100 of the type described makes it possible for FlexRay specification v2.0 to be simply realized, allowing an ASIC or a microcontroller having corresponding FlexRay functionality to be generated in a simple manner.

The described FlexRay communications module 100 is able to fully support the FlexRay protocol specification, in particular v2.0, so that up to 128 messages or message objects may be configured, for instance. The result is a flexibly configurable message memory for storing a different number of message objects as a function of the size of the respective data field or data area of the message. Thus, messages or message objects having data fields of different lengths are advantageously configurable. In this context, message memory 300 is advantageously set up as a FIFO (first-in first-out) memory, so that a configurable receive FIFO is provided. Each message, respectively each message object in the memory may be configured as a receive buffer object (receive buffer), transmit buffer object (transmit buffer), or as a part of the configurable receive FIFO. Likewise possible is an acceptance filtering with respect to frame ID, channel ID and cycle counter within the FlexRay network. Thus, the network management is expediently supported. Moreover, maskable module interrupts are advantageously provided.

The partitioning of message memory 300 is shown in detail in FIG. 3. The functionality of a FlexRay communications controller as required by the FlexRay protocol specification necessitates a message memory for supplying messages to be transmitted (transmit buffer Tx), as well as for storing messages received without error (receive buffer Rx). A FlexRay protocol permits messages having a data area, thus a payload, of 0 to 254 bytes. As shown in FIG. 2, message memory 300 is part of FlexRay communications module 100. The following describes the method, as well as corresponding message memory 300 for storing messages to be transmitted, as well as received messages, in particular through the use of a random access memory (RAM), the described mechanism making it possible to store a variable number of messages in a message memory of a specified size. The number of storable messages is a function of the size of the data areas of the individual messages, which means, first of all, that it is possible to minimize the size of the memory needed without limiting the size of the data areas of the messages, and secondly, that the memory is optimally utilized. This variable partitioning of an, in particular, RAM-based message memory 300 for a FlexRay communications controller is described in greater detail below.

For the implementation, a message memory having a defined word length of n bits, for example 8, 16, 32, etc., as well as a specified memory depth of m words (m, n as natural numbers) is presented exemplarily. In this instance, message memory 300 is partitioned into two segments, a header segment HS and a data segment DS (payload section, payload segment). Thus, one header area HB and one data area DB are created per message. Thus, for messages 0, 1 through k (k as natural number), header areas HB0, HB1 through HBk and data areas DB0, DB1 through DBk are created. Thus, in one message, the distinction is made between first and second data, the first data corresponding to configuration data and/or status data relating to the FlexRay message, and being stored in each instance in a header area HB (HB0, HB1, . . . , HBk). The second data, which correspond to the actual useful data that are to be transmitted, are stored accordingly in data areas DB (DB0, DB1, . . . , DBk). Thus, a first data volume (measured in bits, bytes or memory words) is obtained per message for the first data, and a second data volume (likewise measured in bits, bytes or memory words) is obtained for the second data of a message, in which case the second data volume may vary per message. Thus, the partitioning between header segment HS and data segment DS is variable within message memory 300, i.e., there is no specified boundary between the areas. The partition between header segment HS and data segment DS is a function of the number k of messages, as well as of the second data volume, thus the volume of the actual useful data, of one message or of all k messages together. A data pointer DP0, DP1 through DPk is directly assigned to the configuration data KD0, KD1 through KDk of the particular message. In the particular embodiment, a fixed number of memory words, in this case two, is assigned to each header area HB0, HB1 through HBk, so that one configuration datum KD (KD0, KD1, . . . , KDk) and one data pointer DP (DP0, DP1, . . . , DPk) are stored together in one header area HB. This header segment HS having header areas HB, whose size or first data volume is a function of number k of the messages to be stored, is followed by data segment DS for storing actual message data D0, D1 through Dk. With respect to its data volume, this data segment (or data section) DS is dependent on the stored message data, in this case, for example, six words in DB0, one word in DB1, and two words in DBk. Thus, data pointers DP0, DP1 through DPk in question always point to the beginning, thus to the start address of respective data area DB0, DB1 through DBk in which data D0, D1 through Dk of respective messages 0, 1 through k are stored. Therefore, the partitioning of message memory 300 between header segment HS and data segment DS is variable and is a function of the number k of messages themselves, as well as of the particular data volume of one message, and thus of the entire second data volume. If fewer messages are configured, header segment HS becomes smaller and the area in message memory 300 that is becoming available may be used to supplement data segment DS for storing data. This variability makes it possible to ensure optimal memory utilization, thereby permitting the use of smaller memories as well. Thus, available data segment FDS, particularly the size thereof, which is likewise a function of the combination of the number k of stored messages and the particular second data volume of the messages, is therefore minimal and may even become 0.

Besides the use of data pointers, it is also possible to store the first and second data, thus configuration data KD (KD0, KD1, . . . , KDk) and actual data D (D0, D1, . . . , Dk) in a predefinable sequence, so that the sequence of header areas HBO through HBk in header segment HS and the sequence of data areas DB0 through DBk in data segment DS are identical in each instance. In that case, the need for a pointer element could possibly even be eliminated.

In one particular embodiment, the message memory is assigned an error-identifier generator, in particular a parity bit generator element, and an error-identifier checker, in particular a parity bit check element, to ensure the correctness of the stored data in HS and DS, in that one checksum may be co-stored, especially as a parity bit, per memory word or per area (HB and/or DB). Other check identifiers, such as a CRC (cyclic redundancy check), or even higher-level identifiers, such as ECC (error code correction), are conceivable. Thus, in comparison to a fixed partitioning of the message memory, the following advantages are derived:

When programming, the user may decide whether he/she would like to use a larger number of messages having a small data field or a smaller number of messages having a large data field. The available memory capacity may be optimally utilized when configuring messages having a different-sized data area DB. The user has the option of making joint use of one data memory area for different messages.

When the communications controller is implemented on an integrated circuit, the size of message memory 300 may be adjusted by adapting the memory depth (number m of the words) of the memory used to the particular requirements of the application, without altering the other functions of the communications controller.

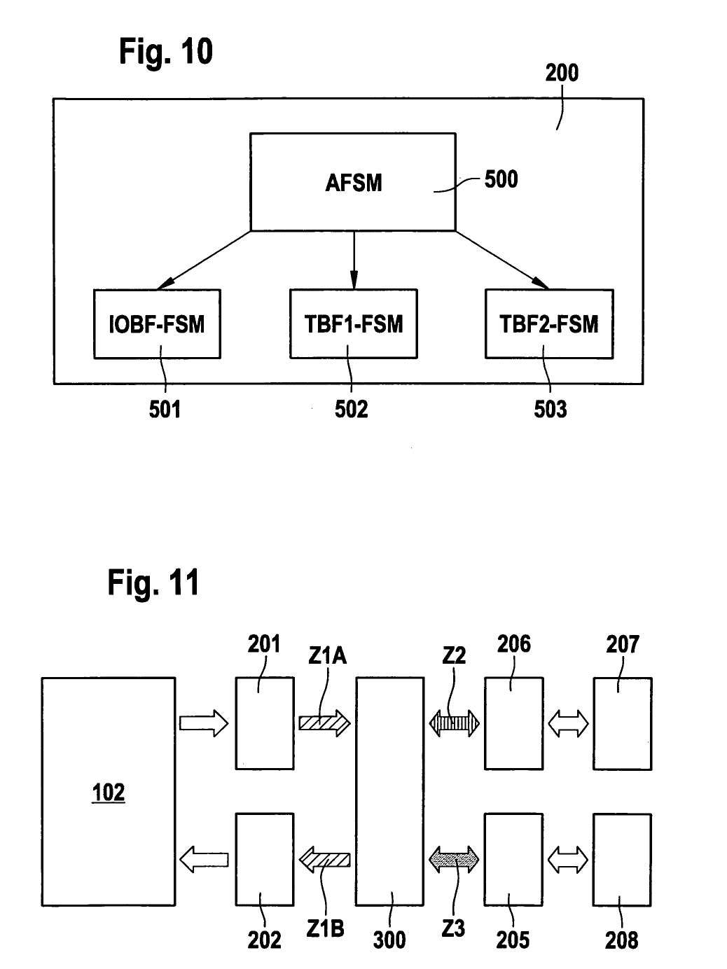

A more detailed description of the host CPU access, thus of the writing and reading of configuration data and status data, respectively, and the actual data via buffer configuration 201 and 202, is provided in the following, with reference to FIGS. 4 through 6 and 7 through 9. The aim in this context is to provide a decoupling of the data transmission in a way that will allow the data integrity to be safeguarded and, at the same time, a high transmission rate to be ensured. These processes are controlled via message handler 200, as is described in greater detail further below with reference to FIGS. 10, 11 and 12.

To begin with, FIGS. 4, 5 and 6 illustrate in greater detail the write accesses to message memory 300 by the host CPU of user CPU 102, via input buffer 201. To that end, FIG. 4 once again shows communications module 100, for the sake of clarity, only those parts of communications module 100 which are relevant here being shown. In the first instance, they include message handler 200, which is responsible for controlling the operational sequences, as well as two control registers 403 and 404 which, as shown, may be accommodated outside of message handler 200 within communications module 100, but may also be contained within message handler 200 itself. In this context, 403 represents the input buffer command request register, IBCR, and 404 represents the input buffer command mask register, IBMR. Thus, write accesses by host CPU 102 to message memory 300 (message RAM) take place via an interposed input buffer 201. This input buffer 201 has a split or double design, namely as a partial buffer 400 and a shadow memory 401 belonging to the partial buffer. This allows host CPU 102 to continuously access the messages or message objects, respectively data of message memory 300, as described in the following, making it possible to ensure data integrity and accelerated transmission.

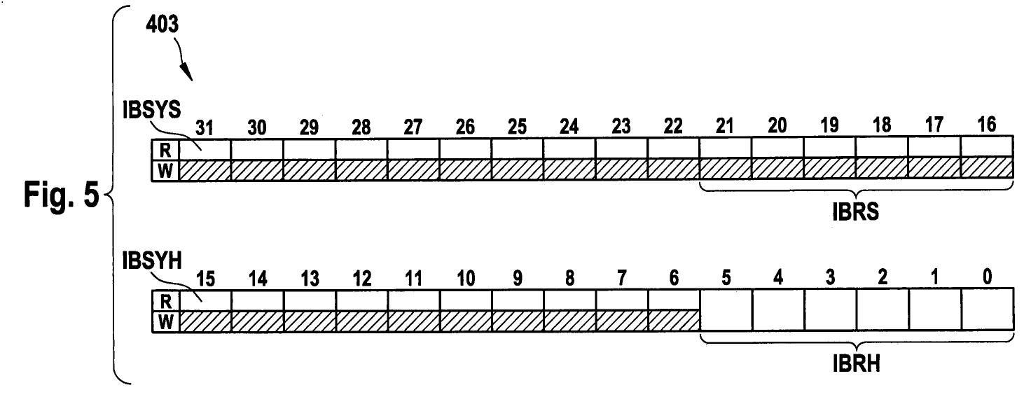

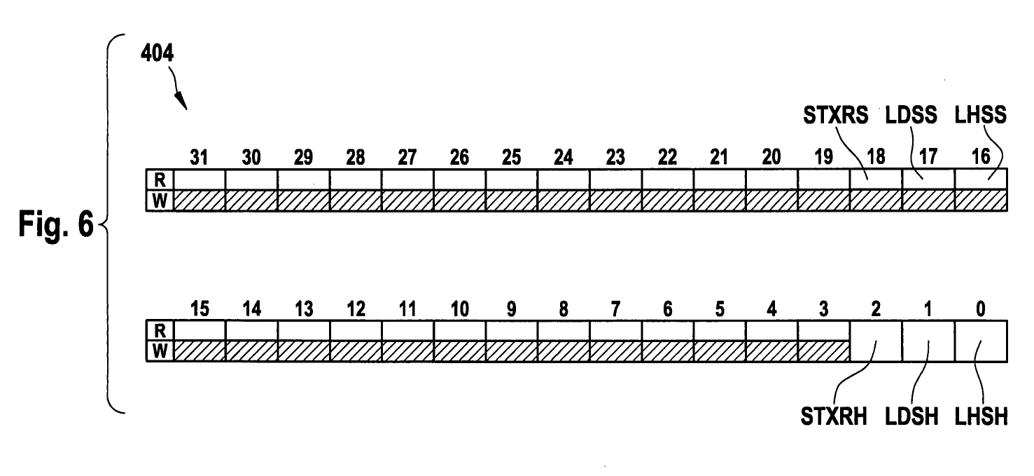

The accesses are controlled via input buffer command request register 403 and via input buffer command mask register 404. In FIG. 5, numbers 0 through 31 represent the respective bit positions in register 403 exemplarily for a width of 32 bits. The same holds for register 404 and bit positions 0 through 31 in mask register 404 from FIG. 6.

Bit positions 0 through 5, 15, 16 through 21 and 31 of register 403 have been assigned a special function in terms of the sequence control, by way of example. Thus, an identifier IBRH (input buffer request host) may be entered as a message identifier into bit positions 0 through 5 of register 403. In the same way, an identifier IBRS (input buffer request shadow) may be entered into bit positions 16 through 21 of register 403. Likewise entered as access identifiers are IBSYH into register position 15 of 403, and IBSYS into register position 31 of 403. Also specially marked are positions 0 through 2 of register 404, other identifiers being entered as data identifiers in 0 and 1 as LHSH (load header section host) and LDSH (load data section host). These data identifiers are in the simplest form here, namely each is constituted of one bit. A start identifier is written as STXRH (set transmission X request host) into bit position 2 of register 404. The sequence of the write access to message memory 300 via input buffer 201 is described in the following.

Host CPU 102 writes the data of the message to be transferred into input buffer 201. In the process, host CPU 102 is only able to write configuration data and header data KD of a message for the header segment HS of message memory 300 or only the actual data D to be transmitted of a message for data segment DS of the message memory 300, or both. Which part of a message, thus configuration data and/or the actual data, is to be transmitted is stipulated by special data identifiers LHSH and LDSH in input buffer command mask register 404. In this context, LHSH (load header section host) determines whether the header data, thus configuration data KD, are to be transmitted, and LDSH (load data section host) determines whether data D are to be transmitted. Due to the fact that input buffer 201 has a two-part design made up of partial buffer 400 as one part and shadow memory 401 corresponding thereto, and access is to take place in an alternating process, two further data-identifier areas, which, at this point, are specific to shadow memory 401, are provided as a counterpart to LHSH and LDSH. These data identifiers in bit positions 16 and 17 of register 404 are denoted by LHSS (load header section shadow) and LDSS (load data section shadow). Thus, they control the transmission process with respect to shadow memory 401.

If the start bit or start identifier STXRH (set transmission X request host) is now set in bit position 2 of input buffer command mask register 404, then after configuration data and/or actual data have been transferred into message memory 300, a transmission request is automatically set for the corresponding message object. This means that this start identifier STXRH automatically controls, in particular starts, the automatic sending of a message object to be transmitted.

The counterpart corresponding thereto for shadow memory 401 is start identifier STXRS (set transmission X request shadow) which is contained by way of example in bit position 18 of input buffer command mask register 404, and, here as well, is likewise constituted as one bit in the simplest case. The function of STXRS is analogous to that of STXRH, but is merely specific to shadow memory 401.

When host CPU 102 writes the message identifier, in particular the number of the message object in message memory 300, into which the data of input buffer 201 are to be transferred, into bit positions 0 through 5 of input buffer command request register 403, thus according to IBRH, partial buffer 400 of input buffer 201 and corresponding shadow memory 401 are interchanged, respectively the particular access by host CPU 102 and message memory 300 to the two partial buffers 400 and 401 is interchanged, as indicated by the semicircular arrows. In the process, the data transfer, thus the data transmission to message memory 300 is also started, for example. The data transmission to message memory 300 itself takes place from shadow memory 401. At the same time, register areas IBRH and IBRS are exchanged. LHSH and LDSH are likewise exchanged for LHSS and LDSS. STXRH is likewise exchanged with STXRS. Therefore, IBRS indicates the identifier of the message, thus the number of the message object for which a transmission, thus a transfer from shadow memory 401 is in progress, respectively which message object, thus which area in message memory 300 most recently received data (KD and/or D) from shadow memory 401. The identifier (here again, for example, 1 bit) IBSYS (input buffer busy shadow) in bit position 31 of input buffer command request register 403 indicates whether a transmission is currently in progress, with the participation of shadow memory 401. Thus, for example, when IBSYS=1, a transmission is currently in progress from shadow memory 401, and when IBSYS=0, it is not. This bit IBSYS is set, for example, by the writing of IBRH, thus in bit positions 0 through 5 in register 403, to indicate that a transfer between shadow memory 401 and message memory 300 is in progress. Once this data transmission to message memory 300 has ended, IBSYS is reset again.

It is right during the data transfer from shadow memory 401 that host CPU 102 may write the next message to be transferred into input buffer 201, respectively into partial buffer 400. The identifier may be refined still further by using an additional access identifier IBSYH (input buffer busy host), for example in bit position 15 of register 403. If host CPU 102 writes IBRH, thus bit positions 0 through 5 of register 403, right when a transmission between shadow memory 401 and message memory 300 is in progress, thus when IBSYS=1, then IBSYH is set in input buffer command request register 403. Upon conclusion of the active transfer, thus of the active transmission in progress, the requested transfer (request through STXRH, see above) is started, and bit IBSYH is reset. Bit IBSYS remains set for the entire time in order to indicate that data are being transferred to message memory 300. All of the bits used in all of the exemplary embodiments may also be constituted as identifiers having more than one bit. A one-bit approach is advantageous from a standpoint of memory and processing efficiency.

The thus described mechanism makes it possible for host CPU 102 to continually transfer data into the message objects that are located in message memory 300 and composed of header area HB and data area DB, provided that the access speed of host CPU 102 to input buffer 201 is less than or equal to the internal data transfer rate of the FlexRay IP module, thus of communications module 100.

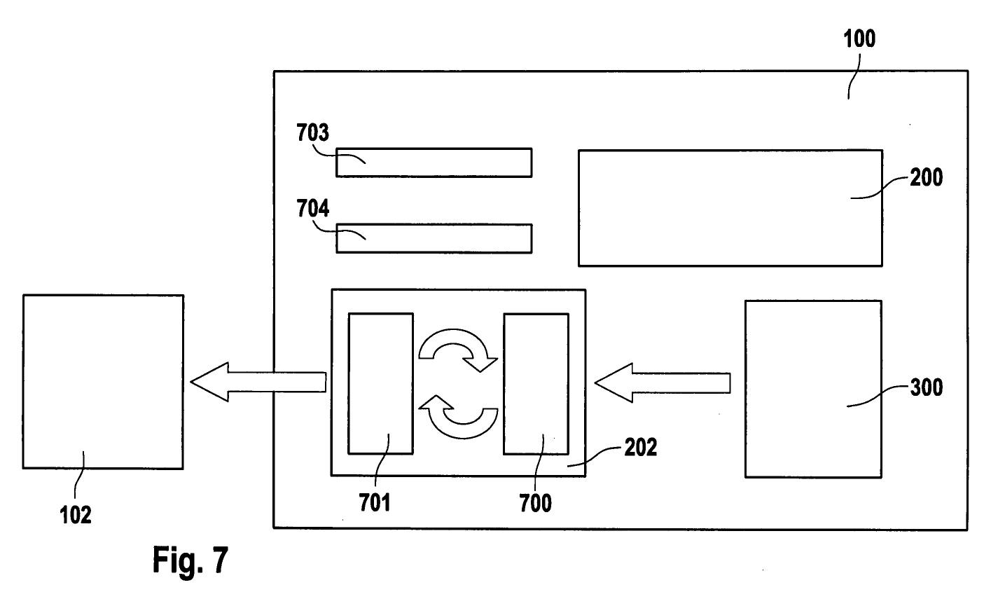

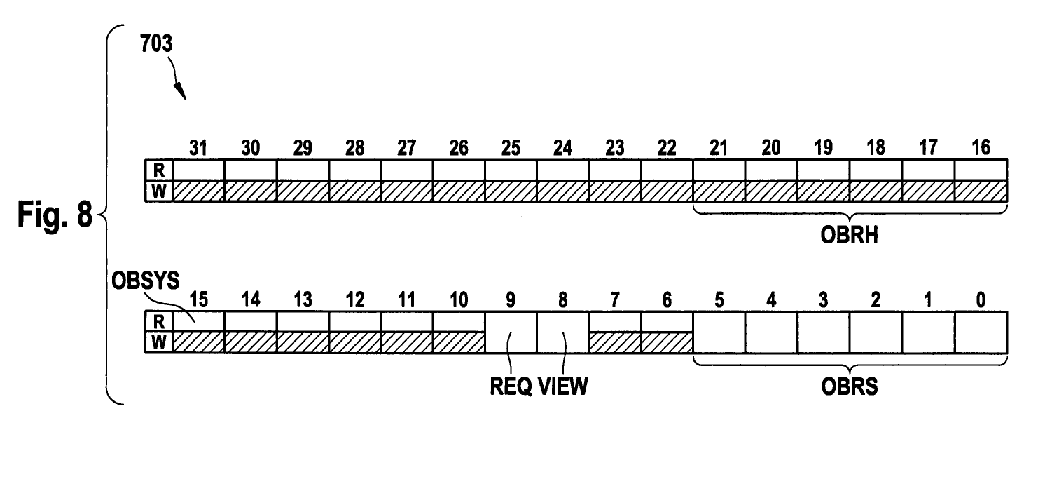

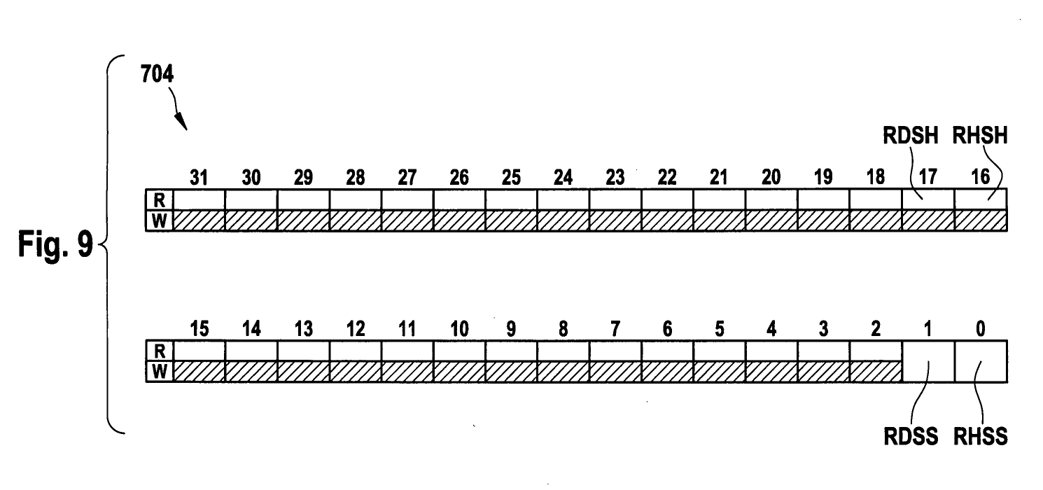

The read accesses to message memory 300 by host CPU or user CPU 102 via output buffer 202 are illustrated in greater detail in FIGS. 7, 8 and 9. To that end, FIG. 7 once again shows communications module 100, for the sake of clarity, only those parts of communications module 100 which are relevant here being shown. In the first instance, they include message handler 200, which is responsible for controlling the operational sequences, as well as two control registers 703 and 704 which, as shown, may be accommodated outside of message handler 200 within communications module 100, but may also be contained within message handler 200 itself. In this context, 703 represents the output buffer command request register, OBCR, and 704 the output buffer command mask register, OBCM. Thus, read accesses by host CPU 102 to message memory 300 take place via interposed output buffer 202. This output buffer 202 likewise has a split or double design, namely as a partial buffer 701 and a shadow memory 700 belonging to the partial buffer. This allows host CPU 102 to continuously access the messages or message objects, respectively data of message memory 300, as described in the following, making it possible to ensure data integrity and accelerated transmission in the reverse direction from message memory 300 to host 102. The accesses are controlled via output buffer command request register 703 and via output buffer command mask register 704. Numbers 0 through 31 represent the respective bit positions in register 703 as well, exemplarily for a width of 32 bits (compare FIG. 8). The same holds for register 704 and bit positions 0 through 31 in 704 (compare FIG. 9).

Bit positions 0 through 5, 8 and 9, 15 and 16 through 21 of register 703 have been assigned a special function in terms of the sequence control of the read access, by way of example. Thus, an identifier OBRS (output buffer request shadow) may be entered as a message identifier into bit positions 0 through 5 of register 703. In the same way, an identifier OBRH (output buffer request host) may be entered into bit positions 16 through 21 of register 703. An identifier OBSYS (output buffer busy shadow) may be entered as access identifier into bit position 15 of register 703. Also specially marked are positions 0 and 1 of output buffer command mask register 704, other identifiers being entered as data identifiers in bit positions 0 and 1 as RDSS (read data section shadow) and RHSS (read header section shadow). Additional data identifiers are provided, for example, in bit positions 16 and 17 as RDSH (read data section host) and RHSH (read header section host). These data identifiers are also in the simplest form here by way of example, namely each is constituted of one bit. A start identifier REQ is entered into bit position 9 of register 703. A changeover identifier VIEW is also provided, which is entered exemplarily into bit position 8 of register 703.

Host CPU 102 requests the data of a message object from message memory 300 by writing the identifier of the desired message, thus, in particular, the number of the desired message object, according to OBRS, thus into bit positions 0 through 5 of register 703. As in the case of the reverse direction, host CPU 102 may also either read only the status or configuration data and header data KD of a message, thus from a header area, or may only read data D of a message actually to be transmitted, thus from the data area, or also both. The portion of the data that is to be transmitted from the header area and/or data area is determined in this instance by RHSS and RDSS, in a manner comparable to that of the reverse direction. This means that RHSS indicates whether the header data are to be read, and RDSS indicates whether the actual data are to be read.

A start identifier is used for the purpose of starting the transmission from message memory 300 to shadow memory 700. This means that if a bit is used as an identifier, as in the simplest case, the transmission from message memory 300 to shadow memory 700 is started by setting bit REQ in bit position 9 in output buffer command request register 703. The transmission in progress is again indicated by an access identifier, here again in the simplest case by one bit OBSYS in register 703. In order to avoid collisions, it is beneficial when bit REQ is only able to be set when OBSYS is not set, thus when no transmission is currently in progress. The message transfer between message memory 300 and shadow memory 700 takes place then in this instance as well. At this point, the actual sequence could be controlled and carried out in a manner comparable to that of the reverse direction, as described under FIGS. 4, 5 and 6 (complementary register assignment), or, however, in a variation, using an additional identifier, namely a changeover identifier VIEW in bit position 8 of register 703. This means that, upon completion of the transmission, the OBSYS bit is reset, and, by setting the VIEW bit in output buffer command request register 703, partial buffer 701 and corresponding shadow memory 700 are exchanged, i.e., the accesses thereto are exchanged, and host CPU 102 is able to read the message object requested by message memory 300, thus the corresponding message from partial buffer 701. In the process, register cells OBRS and OBRH are exchanged in this case as well, in a manner comparable to that of the reverse transmission direction in FIGS. 4 through 6. RHSS and RDSS are likewise exchanged for RHSH and RDSH. As a protective mechanism, it may also be provided in this case for the VIEW bit to only be set when OBSYS is not set, thus when no active transmission is currently in progress.

Thus, read accesses by host CPU 102 to message memory 300 are carried out via interposed output buffer 202. This output buffer 202 has a split or double design similar to that of input buffer 201, in order to ensure a continuous access by host CPU 102 to the message objects stored in message memory 300. The advantages of high data integrity and accelerated transmission are accomplished in this case as well.

The use of the described input and output buffers 201, 202 ensures that a host CPU 102 is able to access message memory 300 without interruption, in spite of the latency times internal to the module.

To safeguard this data integrity, the data transmission, in particular the routing within communications module 100, is undertaken by message handler (MHD) 200. To that end, message handler 200 is shown in FIG. 10. With respect to its functionality, message handler 200 may be described as a plurality of state machines or finite automata, so-called finite state machines (FSM). At least three finite state machines are provided in this instance, and four finite state machines are provided in one special specific embodiment. A first finite state machine is the IOBF-FSM (input/output buffer state machine), designated by 501. Depending on the transmission direction with respect to input buffer 201 or output buffer 202, this IOBF-FSM could also be split into two finite state machines, IBF-FSM (input buffer FSM) and OBF-FSM (output buffer FSM), a maximum of five finite automata (IBF-FSM, OBF-FSM, TBF1-FSM, TBF2-FSM, AFSM) being conceivable. It is may be better, however, to provide one shared IOBF-FSM. In the context of the exemplary embodiment, a second finite state machine is split into two blocks 502 and 503, and controls the operation of the two channels A and B with respect to buffers 205 and 206, as described with reference to FIG. 2. It may be provided for one finite state machine to control the operation of both channels A and B or, however, as in the described form, for one finite state machine TBF1-FSM denoted by 502 (transient buffer 1 (206, RAM A) state machine) for channel A, and one TBF2-FSM denoted by 503 (transient buffer 2 (205, RAM B) state machine) for channel B.

In the exemplary embodiment, an arbiter finite state machine, the so-called AFSM, denoted by 500, is used to control the access by the three finite state machines 501-503. The data (KD and/or D) are transmitted in communications module 100 at a clock pulse that is generated by a clock generator arrangement, such as a VCO (voltage controlled oscillator), for example, a quartz oscillator, etc., or that is adapted therefrom. Clock pulse T may be generated within the module or be externally input, for example as a bus clock pulse. This arbiter finite state machine AFSM 500 alternately grants one of the three finite state machines 501-503 access to message memory 300, in particular for one clock pulse period T at a time. This means that the available time is divided among these requesting finite automata in accordance with the access requests made by the individual finite automata 501, 502, 503. If an access request is made by only one finite state machine, then it receives 100% of the access time, thus all clock pulse periods T. If an access request is made by two finite automata, then each finite state machine is granted 50% of the access time. Finally, if an access request is made by three finite automata, then each of the finite state machines is granted ⅓ of the access time. As a result, the bandwidth available in each case is optimally utilized.

First finite state machine 501, thus IOBF-FSM, executes the following actions, as needed:
data transfer from input buffer 201 to the selected message object in message memory 300;
data transfer from the selected message object in message memory 300 to output buffer 202.

State machine 502 for channel A, thus TBF1-FSM, executes the following actions:
data transfer from the selected message object in message memory 300 to buffer 206 of channel A;
data transfer from buffer 206 to the selected message object in message memory 300;
search for the matching message object in message memory 300, during reception, the message object (receive buffer) is searched for in the course of an acceptance filtering, in order to store a message received on channel A, and, during transmission, the next message object (transmit buffer) to be transmitted on channel A is searched for.

The action of TBF2-FSM, thus of the finite state machine for channel B in block 503, is analogous thereto. It executes the data transfer from the selected message object in message memory 300 to buffer 205 of channel B and the data transfer from buffer 205 to the selected message object in message memory 300. The search function for a matching message object in message memory 300 is also analogous to TBF1-FSM, during reception, the message object (receive buffer) being searched for in the course of an acceptance filtering, in order to store a message received on channel B, and, during transmission, the next message object (transmit buffer) to be transmitted on channel B being searched for.

The operational sequences and the transmission paths are illustrated again in FIG. 11. The three finite state machines 501-503 control the respective data transmissions among the individual parts. The host CPU is again represented by 102, the input buffer by 201, and the output buffer by 202. The message memory is denoted by 300, and the two buffers for channel A and channel B by 206 and 205. Interface elements 207 and 208 are likewise represented. First finite automaton IOBF-FSM, denoted by 501, controls data transfer Z1A and Z1B, thus from input buffer 201 to message memory 300 and from message memory 300 to output buffer 202. The data transmission takes place via data buses having a word length of 32 bits, for example, any other bit number being possible. The same holds for transmission Z2 between the message memory and buffer 206. This data transmission is controlled by TBF1-FSM, thus state machine 502 for channel A. Transmission Z3 between message memory 300 and buffer 205 is controlled by finite-state automaton TBF2-FSM, thus 503. Here, as well, the data transfer takes place via data buses having an exemplary word length of 32 bits, any other bit number likewise being possible. Normally, the transfer of one complete message object over the transmission paths mentioned requires a plurality of clock pulse periods T. For that reason, the arbiter, thus AFSM 500, allocates the transmission time relative to clock pulse periods T. Thus, FIG. 11 shows the data paths between the buffer components controlled by message handler 200. To safeguard the data integrity of the message objects stored in message memory 300, data should be advantageously exchanged simultaneously on only one of the paths shown, thus on Z1A and Z1B, as well as Z2 and Z3.

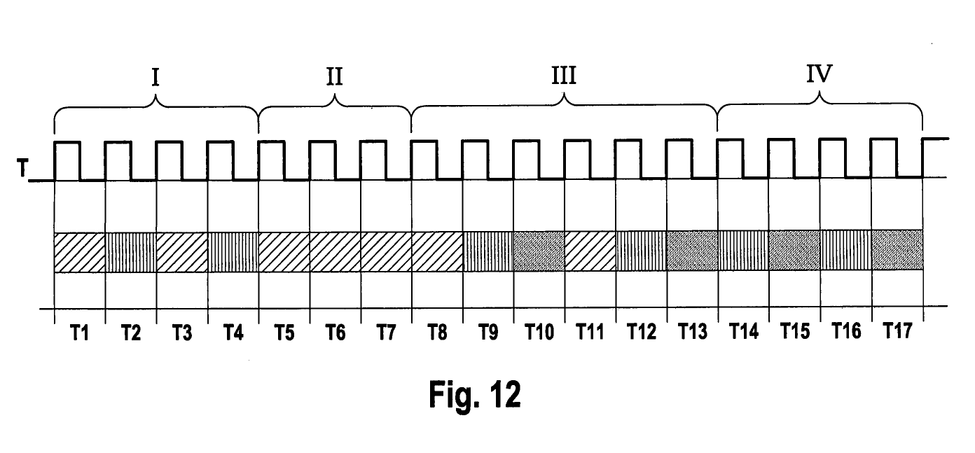

With reference to an example, FIG. 12 shows how the available system clock pulses T are allocated by the arbiter, thus by AFSM 500, among the three requesting finite-state automata. In phase 1 (I), access requests are made by finite-state automaton 501 and finite-state automaton 502, i.e., one half of the entire time is allocated to each of the two requesting finite-state automata. In terms of the clock pulse periods in phase 1 (I), this means that finite-state automaton 501 is granted access in clock pulse periods T1 and T3, and finite-state automaton 502 in clock pulse periods T2 and T4. In phase 2 (II), access is made only by state machine 501, so that all three clock pulse periods, thus 100% of the access time from T5 through T7, is allotted to IOBF-FSM. In phase 3 (III), access requests are made by all three finite-state automata 501 through 503, so that the total access time is divided into thirds. Arbiter AFSM 500 then allocates the access time in such a way, for example, that access is granted to finite state machine 501 in clock pulse periods T8 and T11, to finite state machine 502 in clock pulse periods T9 and T12, and to finite state machine 503 in clock pulse periods T10 and T13. Finally, in phase 4 (IV), two finite-state automata 502 and 503 access the two channels A and B of communications module 100, so that access to finite state machine 502 is distributed among clock pulse periods T14 and T16 and, to finite state machine 503, among T15 and T17.

Thus, when more than one of three state machines 501-503 requests access to message memory 300, arbiter finite-state automaton AFSM 500 ensures that the access is allocated in a clocked and alternating process among requesting state machines 501-503. This procedure safeguards the integrity of the message objects stored in message memory 300, thus the data integrity. If, for example, host CPU 102 would like to read out a message object via output buffer 202 precisely at the moment when a received message is being written into this message object, then, depending upon which request was started first, either the old state or the new state is read out, without the accesses in the message object in message memory 300 itself colliding.

The described method allows host CPU 102 to read or to write any given message object in message memory 300 during continuous operation, without the selected message object being blocked from participating in the data exchange on both channels of FlexRay bus 101 for the duration of the access by host CPU 102 (buffer locking). At the same time, the integrity of the data stored in message memory 300 is safeguarded by the clocked interleaving of the accesses, and the transmission rate is increased, also due to utilization of the full bandwidth.

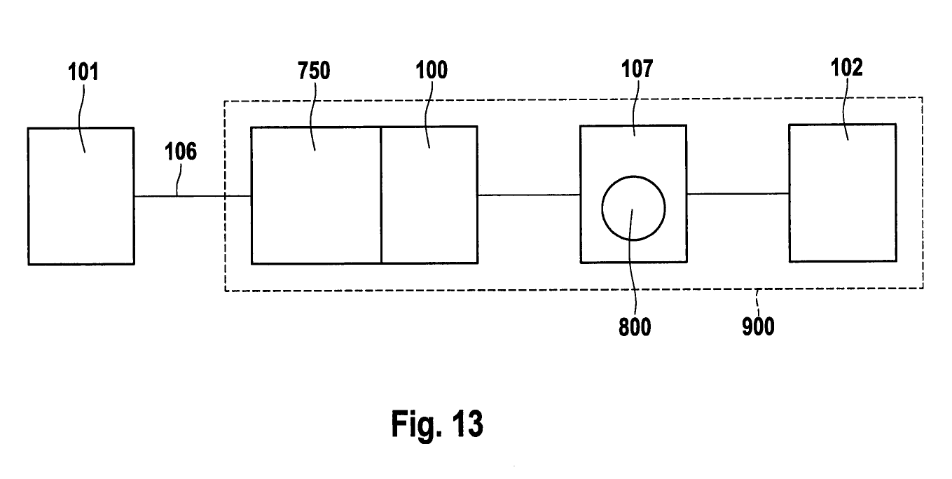

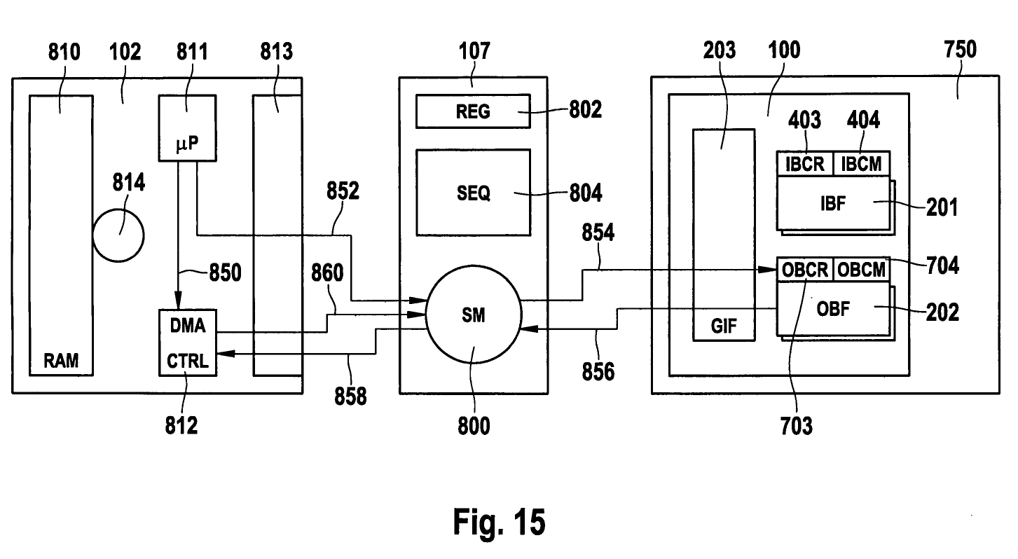

In FIG. 13, a communications user according to the exemplary embodiments and/or exemplary methods of the present invention is schematically denoted in its entirety by reference numeral 900. User 900 is connected via a connection 106 to a communications link 101, which is designed, for example, as a FlexRay data bus. Via communications link 101, user 900 may exchange information (or data or messages) with other connected users (not shown). User 900 includes a microcontroller 102 (host CPU) and a communications controller 750 (CC), which is designed, for example, as a FlexRay communications controller. Communications controller 705 includes a FlexRay communications module 100, which is already described in detail hereinabove. Communications module 100 may be designed as an integral part of communications controller 705 or as a separate component. To improve the connection between FlexRay communications module 100 and microcontroller 102, more precisely, to improve the connection between a message memory 300 of communications module 100 and a DMA (direct memory access) controller 812 (compare FIG. 15) of microcontroller 102, the exemplary embodiments and/or exemplary methods of the present invention provides for a state machine 800 to be located within user interface 107 (customer interface; CIF) between communications module 100 and microcontroller 102. State machine 800 may be hardwired.

State machine 800 modifies user interface 107 in a way that makes it worthwhile to set up and start DMA controller 812 of microcontroller 102. In other words, state machine 800 ensures that the data or messages to be transmitted are presented as optimized data or messages to DMA controller 812, allowing it to transmit even greater data volumes or a plurality of messages in response to one single invocation of DMA controller 812. Thus, in accordance with the exemplary embodiments and/or exemplary methods of the present invention, one single access is effectively composed of the previously required many small accesses, i.e., fewer contiguous address ranges that DMA controller 812 is able to effectively access are, in effect, generated from many segmented address ranges having data. Moreover, by using state machine 800, it is possible to avoid latency times of microprocessor 811 of microcontroller 102 during the data transmission.

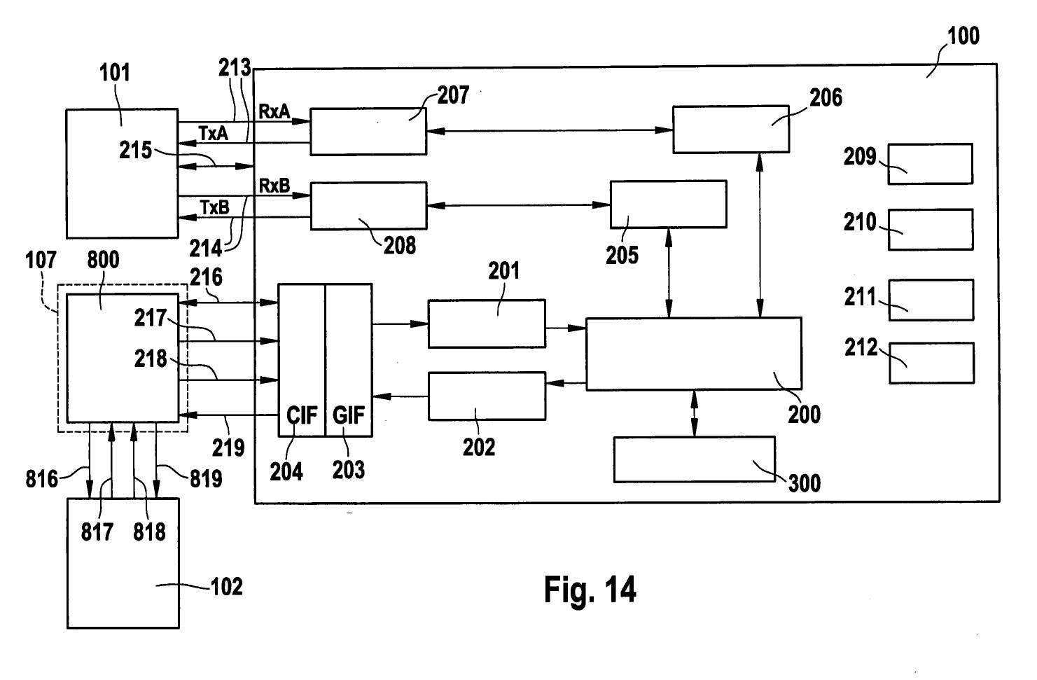

The connection of state machine 800 to communications module 100 and to microcontroller 102 is illustrated in detail in FIG. 14. In particular, user-specific submodule 204 (customer CPU interface; CIF) connects state machine 800 to FlexRay communications module 100. To that end, a bidirectional data line 216, an address line 217, as well as a control input 218 are provided. An interrupt output denoted by 219 is likewise provided. User-specific submodule 204 communicates with user-independent submodule 203 (generic CPU interface, GIF), i.e., FlexRay communications module 100 has a generic, thus general CPU interface 203, to which a large number of different customer-specific users 900 are connectable via corresponding user-specific submodules 204 (CIF). Thus, it is merely necessary to vary submodule 204 as a function of user 900, signifying a substantially lower outlay. CPU interface 203 and remaining communications module 100 may be taken over without modification.

State machine 800 may be part of user-specific submodule 204 (CIF). Of course, it is conceivable, however, for intelligent user interface 107 in accordance with the exemplary embodiments and/or exemplary methods of the present invention to be designed as a separate component.

User interface 107, respectively state machine 800, is connected via a plurality of lines to microcontroller 102. In particular, a bidirectional data line 816, an address line 817, as well as a control input 818 are provided. An interrupt output denoted by 819 is likewise provided.

In FIG. 15, the various signal routes for a read operation (read) are illustrated along the lines of the method of the present invention. In addition, microcontroller 102 is shown in detail. It includes a memory 810, which may be designed, for example, as a random access memory (RAM). Memory 810 is used for storing incoming messages prior to a further processing, and outgoing messages prior to a transmission over communications link 101. Moreover, microcontroller 102 includes a microprocessor 811, a so-called host CPU, a DMA controller 812 and an interface 813 for peripheral modules (for example, a so-called expansion bus module). An internal arbiter unit is denoted by reference numeral 814.

User interface 107 according to the present invention includes state machine 800. Moreover, interface 107 includes at least one register 802, which has a 64-bit size, for example, and is used for configuring state machine 800, respectively the data transmission controlled by state machine 800. To that end, bits are set to this effect in configuration register 802 in order to select the direction of the data transmission (read or write), identifiers (for example message numbers) of the messages to be transmitted, transmission sequence of the messages, length of the messages, or one of a plurality of subsequences stored in advance for purposes of data transmission, for example. The configuration parameters may also pertain to the number of data words to be transmitted or any other given information regarding the pending data transmission.

Moreover, user interface 107 has a sequence memory 804, which is designed, for example, as a random access memory (RAM). In sequence RAM 804, references to specific messages stored in message memory 300, as well as information pertaining to the messages are stored. To coordinate and control the data transmission, state machine 800 invokes entries in sequence memory 804. Sequence memory 804 includes a plurality of, and which may be 128, fields having sequence entries. The sequence entries pertain, for example, to an identifier (for instance a number) of the sequence entry, an identifier or a reference (for instance a buffer number), to one or a plurality of messages (a so-called buffer) of message memory 300, respectively of buffer memory 201 or 202, and the size of the message (of the buffer). The various sequence entries may be selectively invoked by the state machine in accordance with microprocessor specifications. The sequence entries may be invoked as unmodified entries in the stored form or in an adapted form. In the adapted form, specific parameter values are included when the sequence entry is invoked in order to adapt variable parameters of the sequence entry.

The sequence entries in sequence memory 804 may pertain to frequently occurring transmission sequences which are stored in advance and invoked as needed. In this manner, by invoking one single sequence or subsequence (of one or of a plurality of sequence entries), a transmission of voluminous data may be initiated between message memory 300 and DMA controller 812. When the sequences or subsequences are used, the configuration parameters, which are transmitted at the beginning of the data transmission from microprocessor 811 of microcontroller 102 into configuration and status registers 802, may also include an identifier (for example the numbers) of one or of a plurality of sequence entries which are to be invoked by state machine 800 in the course of the data transmission.

The read operation is initiated as soon as data transmitted over FlexRay data bus 101 have been stored in message memory 300 of FlexRay communications module 100. Once the data are received in message memory 300, an interrupt may be triggered or an appropriate instruction communicated to microcontroller 102. It is also conceivable, however, that the receipt of the data in message memory 300 is recognized by microcontroller 102, for example by regular polling.

At the beginning of the read operation, microprocessor 811 configures DMA controller 812 in one step 850. Microprocessor 811 knows how many data are to be transmitted, the size of the messages, and other information pertaining to the pending data transmission. Microprocessor 811 communicates this information at least partially to DMA controller 812 in step 850. Microprocessor 811 subsequently configures state machine 800 in a step 852, in that configuration parameters are written into configuration register 802. State machine 800 then receives a start instruction from microprocessor 811 and consequently begins the actual data transfer process.

Different program loops are run through for the data transfer. An outer loop begins at the first data buffer to be transmitted. An inner loop begins at the first data word of the first data buffer to be transmitted. For this data word, state machine 800 communicates a request/view instruction 854 to output buffer 202, respectively to configuration registers 703, 704 of output buffer 202, to make the data word visible in output buffer 202. The data word is subsequently read out from message memory 300 via output buffer 202. In a step 856, state machine 800 fetches this data word from output buffer 202 via generic interface 203 (GIF). In this context, only header segment HS, only data segment DS, or both header segment HS and data segment DS may be transmitted. In the case of a transmission of header segment HS and data segment DS, which may be, header segment HS is first transmitted and, subsequently, data segment DS; however, the reverse sequence is also possible.

Via configuration registers 703, 704, output buffer 202, respectively a higher-level control unit of FlexRay communications module 100, receives information and instructions as to which data word is to be transmitted next from message memory 300 into output buffer 202.

At this point, in state machine 800, the data word from output buffer 202 is ready to be fetched by DMA controller 812. This is communicated to DMA controller 812 by a data ready instruction 858. DMA controller 812 then reads in the available data word in a step 860 and passes it on for further processing. DMA controller 812 subsequently waits for next data ready signal 858.

The inner loop is incremented to the next data word of the first data buffer, and the above steps are run through once again until the last data word to be read in of the first data buffer has been successfully read in. The outer loop is subsequently incremented to the next data buffer to be transmitted, and the above steps are run through once again until all data words of the last data buffer to be read in have been successfully read in. A specific data buffer may be read in, for example, by invoking a corresponding subsequence from sequence memory 804. DMA controller 812 subsequently communicates the end of the data transmission to microprocessor 811. This may be accomplished, for example, by an appropriate instruction (data transmission ready) or by an interrupt instruction.

The entire data transmission is controlled and coordinated by state machine 800. It is merely necessary that host CPU 811 initiate the data transmission by request instruction 850; everything else is handled by state machine 800, thereby relieving host CPU 811 of microcontroller 102 to the greatest possible extent.

Thus, in accordance with the exemplary embodiments and/or exemplary methods of the present invention, a conventional user interface 107 is augmented by a state machine 800. At least one sequence of message buffers having the requisite payload length may be programmed into a memory, for example a RAM. The memory may be likewise part of user interface 107 according to the present invention. Each time at least one of the subsequences or total sequences is invoked, it is merely necessary for a DMA controller 812 of user 102 to be triggered once. The (sub)sequences are defined by start/end numbers. A maximum of 128 sequence entries make it possible for different sequences to be used, for example during read/write processes. A simultaneous reading and writing per DMA does not occur. A new request instruction 850 may not be started until a DMA sequence has been completely processed. In the case of an error, an interrupt is sent or a flag is set.

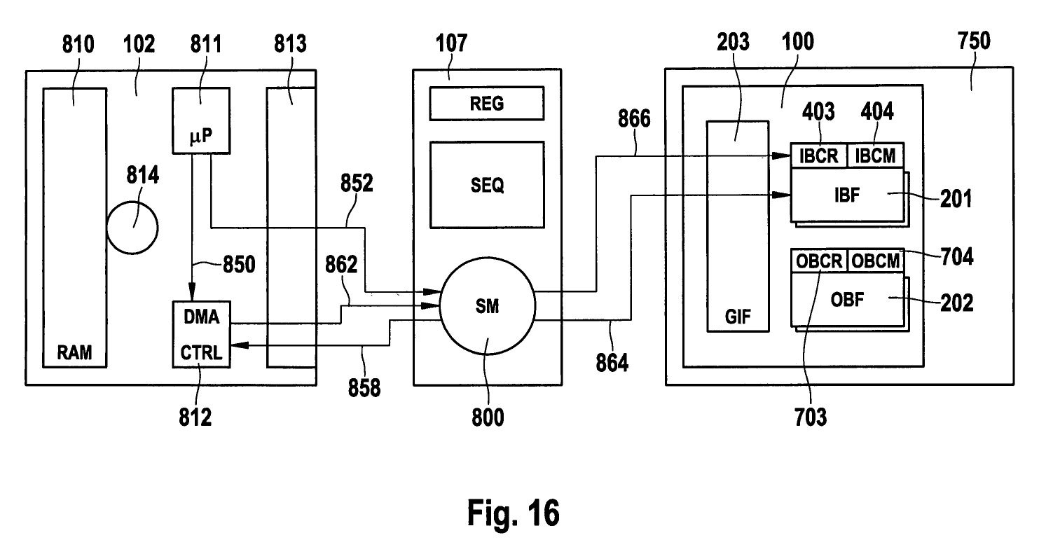

In FIG. 16, the signal routes for writing data (write) into message memory 300 of communications module 100 are illustrated. The write operation is carried out in a process quite similar to the read operation. In essence, only the differences between the read and write operations are discussed in greater detail in the following. At the beginning of the write operation, microprocessor 811 configures DMA controller 812 in one step 850. Microprocessor 811 subsequently configures state machine 800 in a step 852, in that configuration parameters are written into configuration register 802. State machine 800 then receives a start instruction from microprocessor 811 and consequently begins the actual data transfer process.

For the write operation as well, the outer loop is run through for the data buffer to be actively transmitted, and the inner loop is run through for the data word of the current data buffer to be actively transmitted. In contrast to the process of reading out of data, during the write process, input buffer 201 is first filled (inner loop), and the command is then issued for internal storing in message memory 300 (outer loop).

State machine 800 first communicates a data ready signal 858 to DMA controller 812, signaling its readiness to receive the active data word from DMA controller 812. In a step 862, DMA controller 812 then transmits the pending data word to state machine 800. From there, the data word is then sent in a step 864 to input buffer 201 of FlexRay communications module 100.

Once the inner loop is complete, the following is then carried out as part of the outer loop. In a step 866, input buffer 201, respectively a higher-level control unit of FlexRay communications module 100, receives information and instructions as to which location in message memory 300 the data word stored in input buffer 201 is to be stored. For this purpose, appropriate information is stored in one or a plurality of configuration registers 403, 404, for example by setting bits to this effect. The data word from input buffer 201 is subsequently stored at the appropriate location in message memory 300 from where it is then transmitted by itself or together with other data words from message memory 300 via FlexRay communications link 101.

The inner loop is incremented to the next data word of the first data buffer, and the above steps are run through once again until the last data word of the first data buffer has been successfully written into input buffer 201. The outer loop is subsequently incremented to the next data buffer to be transmitted, and the above steps are run through once again until all data words of the last data buffer to be written have been successfully transmitted to communications module 100. A specific data buffer may written, for example, by invoking a corresponding subsequence from sequence memory 804. DMA controller 812 subsequently communicates the end of the data transmission to microprocessor 811. This may be accomplished, for example, by an appropriate instruction (data transmission ready) or by an interrupt instruction.

In summary, it may be said that, in the context of the above description, the present invention relates to a method and to a device for transmitting data between a microprocessor (host CPU) and a peripheral device, for example in the form of a communications controller, for the purpose of communicating, in particular within FlexRay. The peripheral device may be a FlexRay communications controller 750, which is connected via a connection 106 to a FlexRay communications link 101 designed as a FlexRay data bus, for example. Microprocessor 811 and the peripheral device are part of a communications user 900. Typically, only limited resources are available for the data transmission between the microprocessor host CPU and peripheral device 750, i.e., the bandwidth is limited. This is typically the case when a serial interface is used.

The advantage of programming any given sequences of message buffers into sequence RAM 804 in user interface 107, respectively in FlexRay communications module 100 resides, inter alia, in that the access becomes faster because the commands have the knowledge of the configuration of the data, the access procedures, and the corresponding addresses in the form of another finite-state automaton. In this manner, the configuration of the data, the access procedures and/or the corresponding addresses may be automatically provided, so that they no longer need to be supplied by host CPU 811 and thus no longer need to be transmitted via interface 107, i.e., specifically via lines 216 through 218. In addition, the access procedure (reading/writing) may already be permanently incorporated in this device 107, thus, as already mentioned, likewise no longer need to be transmitted.

Instead, the predefined or preprogrammed subsequences are merely retrieved, respectively activated with respect to the mentioned information (for example, data configuration, access procedure, and/or addresses), and provided with additional values. By invoking one or a plurality of the sequences, a plurality of message buffer contents may be simply and rapidly transmitted from or to communications module 100.

1-11. (canceled)

12. A user interface system, comprising:
a user interface between a FlexRay communications module which is connected to a FlexRay communications link over which messages are transmitted and which includes a message memory for one of buffer storing messages from the FlexRay communications link and for the FlexRay communications link; and
a microcontroller which is assigned to the FlexRay communications module and which includes a microprocessor and a direct memory access (DMA) controller for exchanging data with the message memory;
wherein the user interface has a state machine, which, once configured by the microprocessor of the microcontroller, independently coordinates and controls a data transmission between the message memory of the FlexRay communications module and the DMA controller.

13. The user interface system of claim 12, wherein the user interface includes configuration and status registers that the microprocessor of the microcontroller has access to for configuring the state machine.

14. The user interface system of claim 12, wherein the user interface includes a sequence memory, in which references to specific messages stored in the message memory and information pertaining to the messages are stored, the state machine invoking entries in the sequence memory to coordinate and control the data transmission.

15. The user interface system of claim 12, wherein the FlexRay communications module has at least one input buffer and at least one output buffer for buffer storing data to be transmitted between the message memory of the communications module and the DMA controller, for buffer storing at least one message stored in the message memory, the state machine independently coordinating and controlling the data transmission between the message memory and the at least one buffer, and between the at least one buffer and the DMA controller.

16. The user interface system of claim 15, wherein the at least one buffer includes a partial buffer and one shadow memory belonging to the partial buffer, the state machine coordinating and controlling the data transmission so that the at least one of writing to and reading from the partial buffer and the shadow memory occurs in an alternating process.

17. The user interface system of claim 15, wherein the FlexRay communications module has at least one control register that belongs to the at least one buffer, the state machine having access to the control register to coordinate and control the data transmission between the message memory and the at least one buffer.

18. A FlexRay user system, comprising:
a FlexRay user, which has a microcontroller;
a FlexRay communications module which is connected to a FlexRay communications link over which messages are transmitted and which includes a user interface between the microcontroller and the communications module, the microcontroller including a microprocessor and a direct access memory (DMA) controller, the communications module including a message memory for buffer storing messages from the FlexRay communications link or the FlexRay communications link;
wherein the user interface has a state machine, which, once configured by the microprocessor of the microcontroller, independently coordinates and controls a data transmission between the message memory of the FlexRay communications module and the DMA controller.

19. A method for transmitting data, the method comprising:
transmitting data between a message memory of a FlexRay communications module, which is connected to a FlexRay communications link over which messages are transmitted, and a direct memory access (DMA) controller of a microcontroller;
configuring a state machine, which, as part of a user interface, is located between the microcontroller and the FlexRay communications module, by a microprocessor of the microcontroller; and
following the configuration, independently coordinating and controlling, by the state machine, the data transmission.

20. The method of claim 19, wherein configuration parameters are stored by the microprocessor of the microcontroller in configuration and status registers of the user interface to configure the state machine.

21. The method of claim 19, wherein the user interface has a sequence memory, in which references to specific messages stored in the message memory and information pertaining to the messages are stored, to coordinate and control the data transmission, the state machine invoking entries in the sequence memory.

22. The method of claim 19, wherein the FlexRay communications module has at least one input buffer and at least one output buffer, for buffer storing data to be transmitted between the message memory of the communications module and the DMA controller, for buffer storing at least one message stored in the message memory, and wherein coordination and control parameters are stored by the state machine in the control registers of the at least one buffer to control and coordinate the data transmission.
